(19) United States
(12) Patent Application Publication
(10) Pub. No.: US 2005/0114115 A1
(43) Pub. Date: May 26, 2005

(54) Typing accuracy relaxation system and method in stylus and other keyboards

(76) Inventors: John P. Karidis, Ossining, NY (US); Per Ola Kristensson, Linkoping (SE); Shumin Zhai, San Jose, CA (US)

Correspondence Address: Frederick W. Gibb, III;McGinn & Gibb, PLLC, Suite 304, 2568-A Riva Road, Annapolis, MD, 21401, US

(21) Appl. No.: 10/723,469

(22) Filed: Nov. 26, 2003

(51) Int. Cl. G06F 17/21

(52) U.S. Cl. 704/10

(57) ABSTRACT

A system and method relaxing typing accuracy in stylus or other keyboards comprises recording a coordinate of a keystroke landing point, wherein the keystroke emanates from tapping a key on a keyboard, counting the number of tapped landing points, creating a set of words from a lexicon having the same amount of the tapped landing points, for each letter in each word in the set, computing the distance from the pattern formed by the landing coordinate to the pattern formed by the letters in words in a database, and selecting a word from the set having the shortest total distance, wherein the distance is a mean distance of all the tapped landing points for each word, or wherein the distance is an elastic matching distance between the tapped landing points and the coordinate.

### BACKGROUND OF THE INVENTION

1. Field of the Invention

The present invention generally relates to keystroke typing recognition methods, and more particularly to a typing accuracy relaxation system and method based on the geometric positioning of keystrokes.

2. Description of the Related Art

Within this application several publications are referenced by Arabic numerals. Full citations for these, and other publications may be found at the end of the specification immediately preceding the claims. The disclosures of all these publications in their entireties are hereby expressly incorporated by reference into the present application for the purposes of indicating the background of the present invention and illustrating the state of the art.

A stylus keyboard, also known as an on screen keyboard, graphical keyboard, or virtual keyboard, has two broad categories of use. The first use is in mobile computers such as personal digital assistants (PDA), or tablet personal computers. The other use is for users with various degrees of handicapped disability. A stylus keyboard is typically tapped with one stylus, one finger or other means such as a head tracker, one keystroke at a time.

Human motor control studies have demonstrated that the time T to successfully hit a target key follows Fitts' law as applied to the graphic shown in FIG. 1:
T=a+b+bID (1)

$$ID = {log}_{2} ( \frac{{D}_{ij}}{{W}_{j}} + 1 ) \qquad ( 2 )$$

where Dᵢⱼ is the distance of the stylus movement from key i to key j; Wⱼ is the width of the target key, j; a and b are constants; and ID is the index of difficulty of the task, where i and j represent any pair of keys from A to Z and the space key. Based on such an understanding and the statistical frequency between letters, work has been done on optimizing the key layout for serial movement so that statistically the least amount of time is needed in tapping a key. Getschow^{[1]} describes one of the first efforts in optimizing layouts for disabled typists. MacKenzie^{[2]} explicitly applies Fitts' law and manually manipulates the layout of the keyboard resulting in the OPTI design. Zhai^{[3]} uses advanced optimization algorithms in searching the most efficient layout. The Zhai design also considers alphabetical sequencing and letter connectivity in common words. FIGS. 2(A) through 2(P) illustrate examples of typical Stylus keyboard design layouts. For simplicity, auxiliary keys have been omitted in the representative illustrations shown in FIGS. 2(A) through 2(O). However, auxiliary keys have been included in FIG. 2(P). These and other conventional techniques have attempted to minimize the D constraint in equation (2) above.

One of the key weaknesses of the existing stylus keyboards is in the verbatim process the user must use; that is the user has to tap letter by letter with high accuracy. It is well known that natural languages have a great deal of redundancy, as Shannon^{[4]} observed in the process of creating his information theory. In some text input methods, such as the T9 method commonly used in mobile phones, language redundancy is well exploited. In T9, although each key tap could mean any of the three letters on the key, a series of key taps often constitute only one unique word. Another example is Ward^{[5]} which uses the language regularities to dynamically align letters so the most likely next letter is near the cursor. Moreover, language regularity has been used in typing predictions^{[6]}.

Currently, there is a need for a system and method for exploiting language regularity to relax the accuracy requirement in stylus keyboards so they can be more error tolerant. With a regular stylus keyboard, if a user has certain motor disability, particularly when the keyboard is on a small device such as a PDA, or if a normal user pushes (exceeds) his normal typing speed, the landing points of the stylus often fall outside of a targeted key. In other words the user breaks the W constraint in equation (2) above. This adds to the user's (typist's) frustration and requires additional time and effort to correct these errors.

Goodman has addressed a similar problem with a language modeling approach^{[7]}. Two sources of information are used in Goodman's method. One is the letter sequence in English and the other is a pen down position model. With regard to letter sequence, Goodman uses statistics of the probability of a given letter following a sequence of other letters that have occurred. This is similar to the language models used in speech recognition except at lower (letter) level rather that word level. With regard to pen down positions, Goodman constructs a pen-down model based on his observations that the average position of the pen is not the center of the key; the difference between the horizontal and vertical position variance; the rotation of the 2D pen down distribution, and the difference with respect to the left and right side. However, while the above conventional techniques were satisfactory for the purposes for which they were designed, there remains a need to relax the accuracy requirement of precisely tapping each letter key, thereby effectively increasing the constraints of Win equation (2) above.

### SUMMARY OF THE INVENTION

The invention provides a method of relaxing typing accuracy comprising comparing the geometric pattern formed by the inputted sequence of points to the patterns formed by lexical entries of sequences, calculating a distance between the inputted pattern of points and the patterns of letters corresponding to the lexical entry of sequences, and determining a word by selecting a shortest distance between the inputted pattern and the pattern corresponding to the lexical entry of sequences, wherein the distance is a mean distance of all inputted sequence of points, or wherein the distance is an elastic matching distance between the inputted sequence of points and the lexical entry of sequences. The method further comprises normalizing the elastic matching distance by an amount of letters in the word. Moreover, the method further comprises comparing the shortest total distance to a predetermined threshold distance, wherein the invention outputs the word if the shortest total distance is smaller than the predetermined threshold distance, and wherein the invention outputs the letters tapped if the shortest total distance is greater than the predetermined threshold distance.

In an alternative embodiment, the invention provides a method of relaxing typing accuracy comprising recording a coordinate of at least one keystroke landing point, wherein the keystroke emanates from tapping a key on a keyboard, counting an amount of tapped landing points, creating a set of words from a lexicon having a same number of the tapped landing points, for each letter in each word in the set, computing a distance from the coordinate to a central position of the key corresponding to the letter, summing a total distance for each word, and selecting a word from the set having a shortest total distance to the coordinate, wherein the distance is a mean distance of all the tapped landing points for each word, or wherein the distance is an elastic matching distance between the tapped landing points and the coordinate. The method further comprises normalizing the elastic matching distance by an amount of letters in the word, and comparing the shortest total distance to a predetermined threshold distance. Furthermore, the invention outputs the word if the shortest total distance is smaller than the predetermined threshold distance, and outputs the letters tapped if the shortest total distance is greater than the predetermined threshold distance.

In another embodiment, the invention provides a system of relaxing typing accuracy comprising a comparing module configured to compare an inputted sequence of points to a lexical entry of sequences, a calculator configured to calculate a distance between the inputted sequence of points and letters corresponding to the lexical entry of sequences, and a determining module configured to determine a word by selecting a shortest distance between the inputted sequence of points and letters corresponding to the lexical entry of sequences, wherein the distance is a mean distance of all inputted sequence of points, or wherein the distance is an elastic matching distance between the inputted sequence of points and the lexical entry of sequences. The system further comprises a statistical controller configured to normalize the elastic matching distance by an amount of letters in the word, a comparator configured to compare the shortest total distance to a predetermined threshold distance, and an output unit configured to output the word if the shortest total distance is smaller than the predetermined threshold distance, or output the letters tapped if the shortest total distance is greater than the predetermined threshold distance.

According to the invention it is possible to relax the stringent tapping accuracy requirement for two reasons. One is that not all letter combinations are legitimate words. Thus, the invention exploits these inherent constraints in legitimate words. The simplest implementation of this constraint is a lexicon. Other implementations of letter constraints may include a collection of n-grams, syllables, phonemes etc. The second observation is that the mismatch between the landing point of the stylus and the ideal point, e.g. the center of a key, is a continuous variable that is recorded by the tablet or the touch screen surface. The continuous variable can be used to calculate the deviation of the geometric pattern formed by the landing points from the ideal pattern of a word on a given keyboard layout. The total distances between all points the user tapped and the positions of the corresponding points of the letters in all words in the lexicon can therefore be computed by various methodologies. By analyzing these distances a computer program can return the intended legitimate word to the user, even if one or more letters are mistapped, as long as the match passes a certain threshold. Otherwise the verbatim letter sequence can be returned. Such a method takes advantage of both the lexical constraint in a natural language and the geometry of the keyboard layout. The invention uses a geometric approach to relax the accuracy requirement in stylus keyboards. Moreover, such an approach has the advantage of both conceptual and implementation simplicity.

These, and other aspects and advantages of the present invention will be better appreciated and understood when considered in conjunction with the following description and the accompanying drawings. It should be understood, however, that the following description, while indicating preferred embodiments of the present invention and numerous specific details thereof, is given by way of illustration and not of limitation. Many changes and modifications may be made within the scope of the present invention without departing from the spirit thereof, and the invention includes all such modifications.

### BRIEF DESCRIPTION OF THE DRAWINGS

The invention will be better understood from the following detailed description with reference to the drawings, in which:

FIG. 1 is a schematic diagram illustrating the spatial relationship between two keys on a keyboard layout;

FIG. 2(A) is an example of a conventional QWERTY keyboard layout;

FIG. 2(B) is an example of a conventional square alphabetic keyboard layout;

FIG. 2(C) is an example of an alternative conventional square alphabetic keyboard layout;

FIG. 2(D) is an example of a conventional OPTI keyboard layout;

FIG. 2(E) is an example of a conventional OPTI II keyboard layout;

FIG. 2(F) is an example of a conventional FITALY keyboard layout;

FIG. 2(G) is an example of a conventional Chubon keyboard layout;

FIG. 2(H) is an example of a conventional Lewis-Kennedy-LaLomia keyboard layout;

FIG. 2(I) is an example of an alternative conventional Lewis-Kennedy-LaLomia keyboard layout;

FIG. 2(J) is an example of a conventional Hooke keyboard layout;

FIG. 2(K) is an example of a conventional Metropolis 1 keyboard layout;

FIG. 2(L) is an example of a conventional Metropolis 2 keyboard layout;

FIG. 2(M) is an example of a conventional triangle-shape keyboard layout;

FIG. 2(N) is an example of a conventional alphabetically tuned keyboard layout;

FIG. 2(O) is an example of a conventional ATOMIK keyboard layout;

FIG. 2(P) is an example of a conventional ATOMIK keyboard layout including auxiliary keys;

FIG. 3 is a flow diagram according to a preferred method of the invention;

FIG. 4 is a flow diagram according to an alternative method of the invention;

FIG. 5 is a graphical illustration of an elastic mapping technique according to the invention;

FIG. 6 is an alternate flow diagram according to the invention;

FIG. 7 is a system block diagram according to the invention;

FIG. 8(A) is an example keystroke sequence illustrating the invention;

FIG. 8(B) is an example keystroke sequence illustrating the invention;

FIG. 8(C) is an example keystroke sequence illustrating the invention;

FIG. 9(A) is an example keystroke sequence illustrating the invention; and

FIG. 9(B) is an example keystroke sequence illustrating the invention.

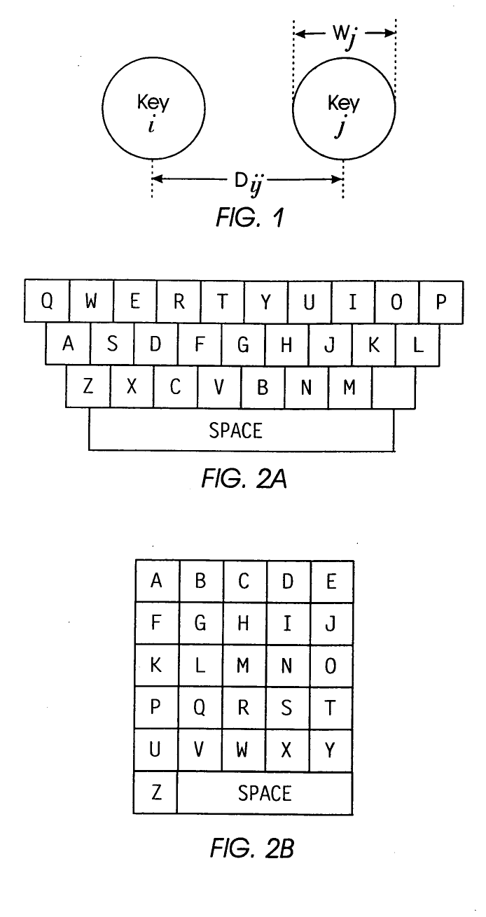

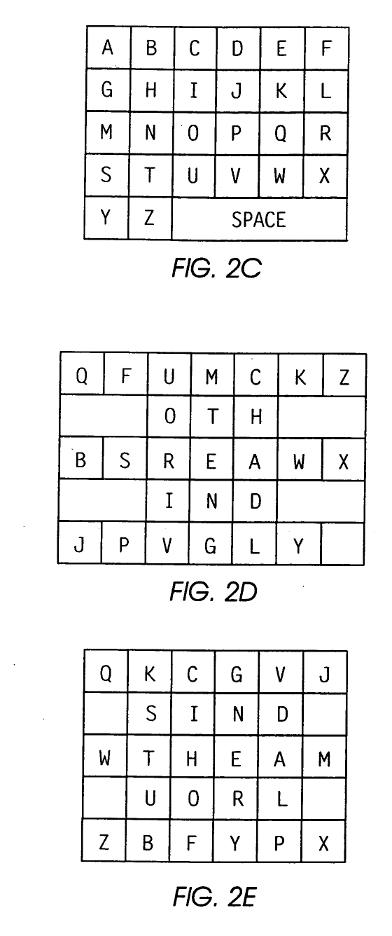

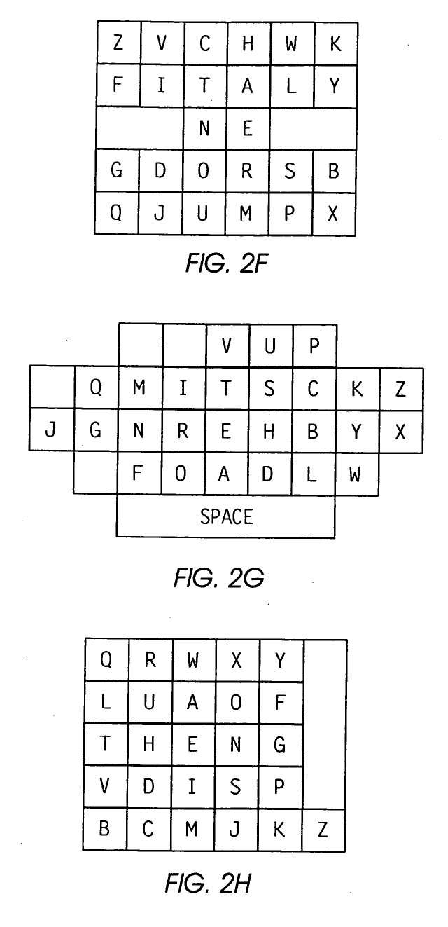

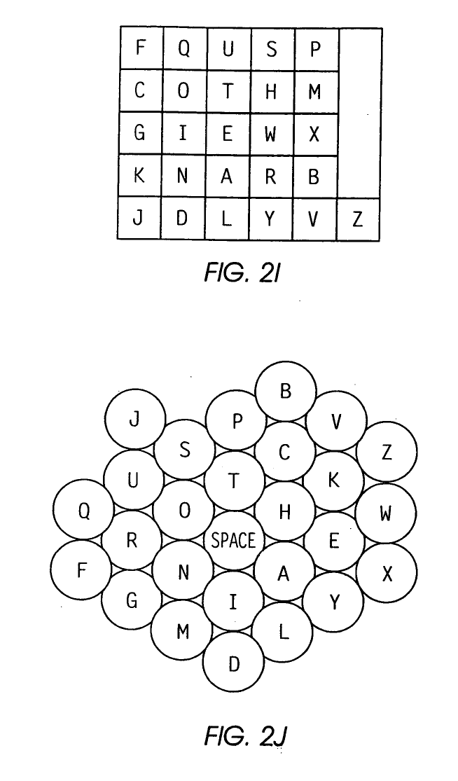

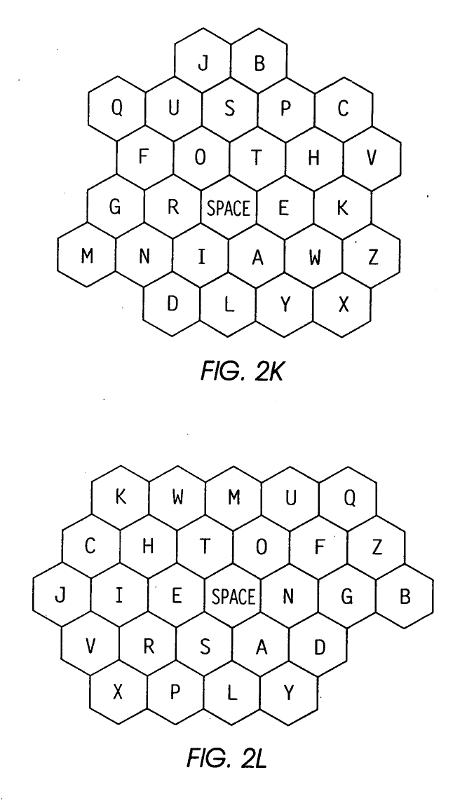

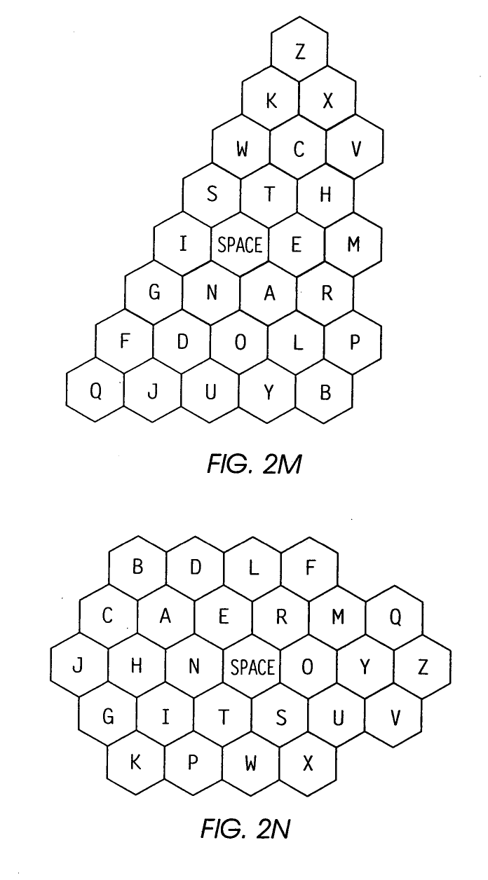

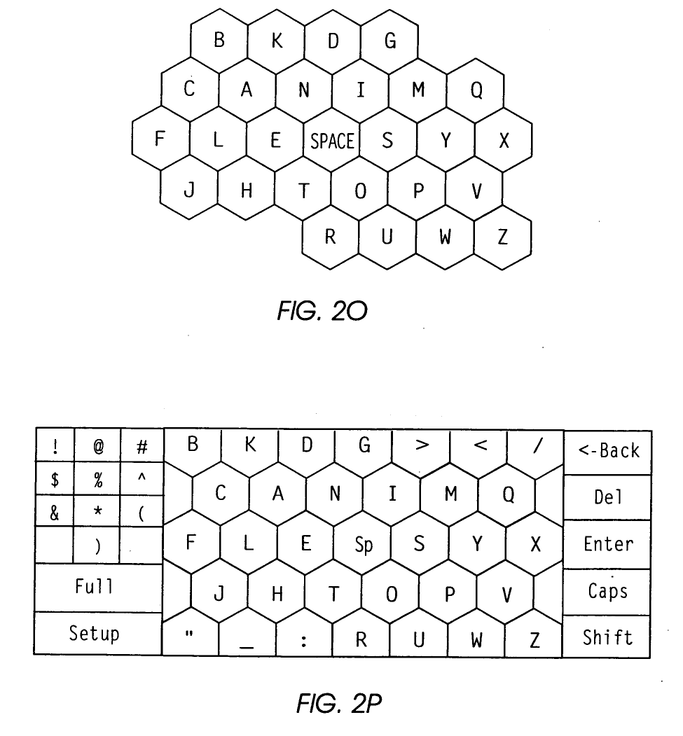

### DETAILED DESCRIPTION OF PREFERRED EMBODIMENTS OF THE INVENTION

The invention and the various features and advantageous details thereof are explained more fully with reference to the non-limiting embodiments that are illustrated in the accompanying drawings and detailed in the following description. It should be noted that the features illustrated in the drawings are not necessarily drawn to scale. Descriptions of well-known components and processing techniques are omitted so as to not unnecessarily obscure the present invention. The examples used herein are intended merely to facilitate an understanding of ways in which the invention may be practiced and to further enable those of skill in the art to practice the invention. Accordingly, the examples should not be construed as limiting the scope of the invention.

As mentioned, there is a need to relax the accuracy requirement of precisely tapping each letter key, thereby increasing the constraints of W in equation (2) above. The invention addresses this problem by computing the geometry of the points tapped and automatically correcting the landing points falling outside the targeted letters, hence giving the user greater ease, confidence, and comfort in using a stylus keyboard. This is particularly desirable for users with disabilities and for users in mobile situations. The invention also works for typing with a regular physical keyboard and as a method used for error correction or spelling check. Therefore, the invention solves the problems and drawbacks associated with the conventional techniques by relaxing the accuracy requirement of precisely tapping on each letter, effectively increasing the constraints of W.

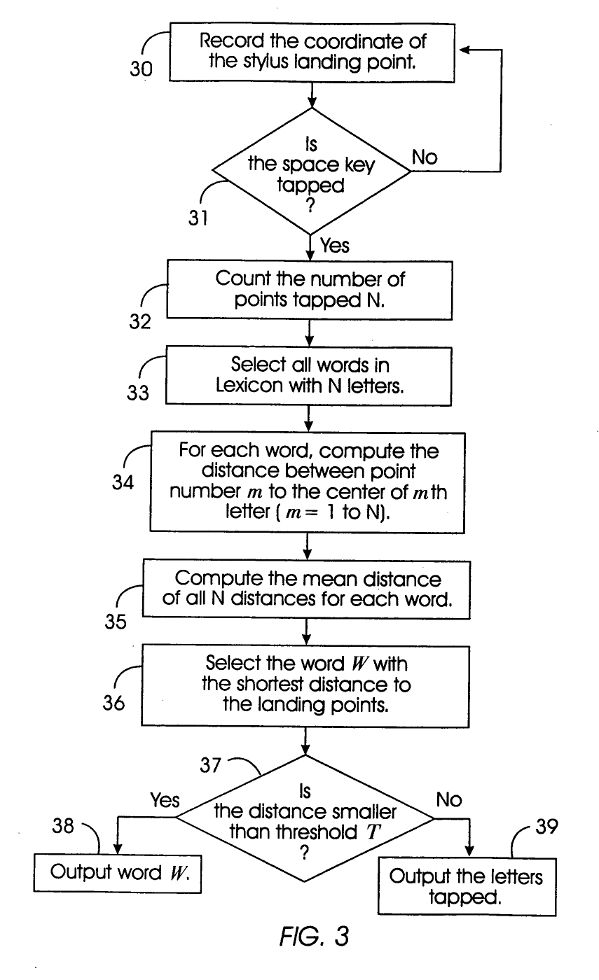

Referring now to the drawings and more particularly to FIGS. 3-9(B) there are shown preferred embodiments of the invention. The invention is based on some assumptions. First, not all letter combinations are legitimate words. Therefore, the invention exploits these inherent constraints. The simplest implementation of this constraint is a lexicon (can also be called a word list, or a dictionary). Other implementations of letter constraints may include a collection of n-grams, syllables, phonemes etc.

Another assumption is that the mismatch between the pattern formed by the landing point of the stylus and pattern formed by the ideal point, i.e., the center of a key, is a continuous variable that is recorded by a tablet or the touch screen surface. The total distances between all points a user taps and the positions of letters in all words in the lexicon can therefore be computed by various pattern recognition algorithms. By analyzing these distances the invention returns the intended legitimate word to the user, even if one or more letters are mistapped (incorrectly typed), as long as a clear match passes a certain threshold. Otherwise the verbatim letter sequence is returned. A user can also switch the auto-correction function on or off by tapping on one button when needed.

FIG. 3 illustrates a decision sequence according to the invention. The lexicon used can be constructed with various methods. For example, it can be a preloaded, standard dictionary, or a list of words extracted from the user's previously written documents, including emails and articles, or words added by the user to the list, or a combination of all. With this method, the number of landing points and their sequence are preferably the same as the letters in the intended word. As illustrated in the flow diagram in FIG. 3, the sequence begins by recording 30 the vector coordinate of the stylus landing point. Next, it is determined 31 whether the space key is tapped. If the space key has not been tapped, then the sequence begins again by recording 30 the vector coordinate of the stylus landing point. If the space key has been tapped, then, the sequence continues to count 32 the number of points tapped (N). Then, a selection 33 of all words in the lexicon with N letters is made. Next, for each word, a computation is made 34 of the distance between point mth point of the stylus landing sequence and the center of the mth letter in the word (m=1 to N). With respect to FIG. 3, m refers to the mth point in the sequence of pen landing or letter, and also the mth letter in the word. Next, the sequence provides a computation 35 of the mean distance of all N distances for each word. The next step involves selecting 36 the word W with the shortest distance to the landing points. Upon completion of this step, a decision 37 is made whether the distance is smaller than a threshold distance T. If the distance is smaller than T then the word W is outputted 38. If the distance is not smaller than T then the letters tapped are outputted 39. T is an empirically adjusted quantity, ranging from half of one key width to a few times of a key width. In order to ensure that the geometry deviation is not too disproportional, a separate threshold on each individual point distance is also imposed. This threshold is greater than the mean total distance previously discussed.

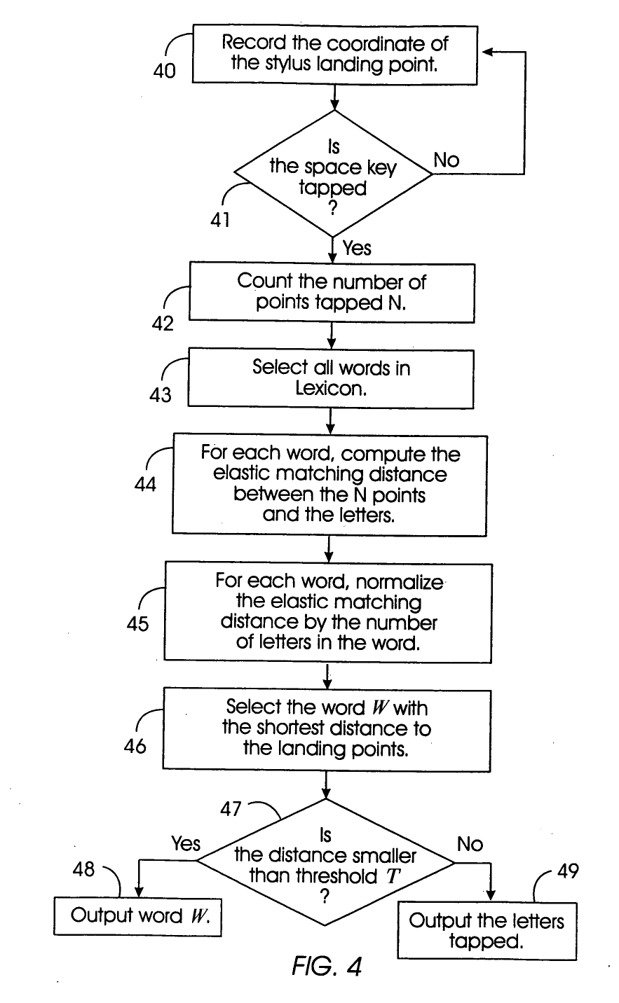

FIG. 4 shows an alternative method of the invention. As illustrated in the flow diagram in FIG. 4, the sequence begins by recording 40 the vector coordinate of the stylus landing point. Next, it is determined 41 whether the space key is tapped. If the space key has not been tapped, then the sequence begins again by recording 40 the vector coordinate of the stylus landing point. If the space key has been tapped, then, the sequence continues to count 42 the number of points tapped (N). Then, a selection 43 of all words in the lexicon with N letters is made. Next, for each word, a computation is made 44 of the elastic matching distance between the N points and the letters. The next step of the process is to, for each word, normalize 45 the elastic matching distance by the number of letters in the word. The next step involves selecting 46 the word W with the shortest distance to the landing points. Upon completion of this step, a decision 47 is made whether the distance is smaller than a threshold distance T. If the distance is smaller than T, then the word W is outputted 48. If the distance is not smaller than T then the letters tapped are outputted 49. T is an empirically adjusted quantity, ranging from half of one key width to a few times a key width. For saving computational resources, a word can be rejected as soon as the cumulated distance is greater than the threshold, without completing the entire match.

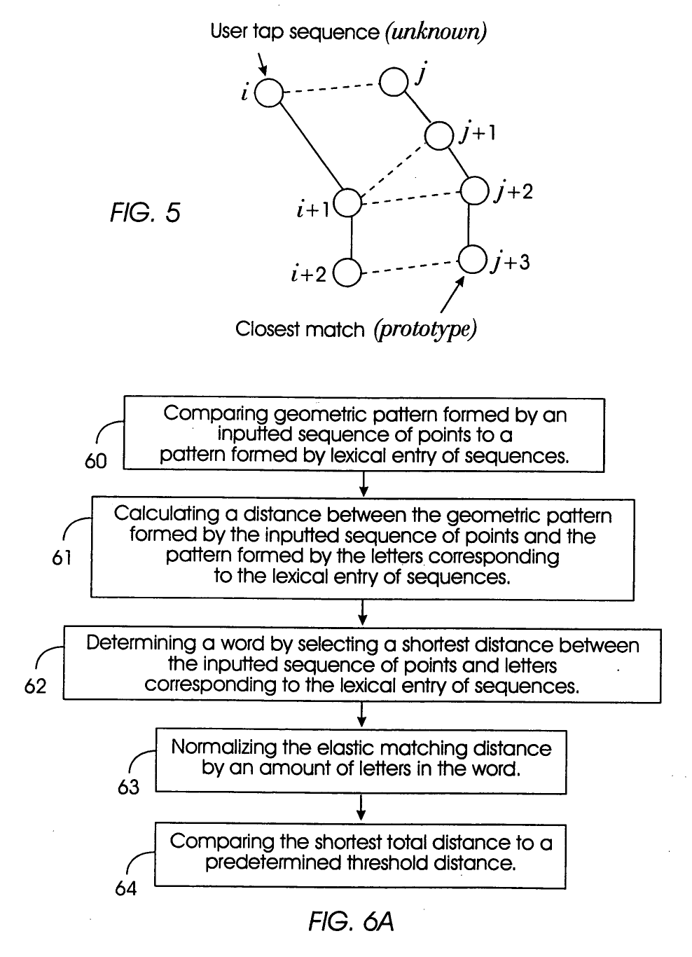

The two methods (FIG. 3 vs. FIG. 4) described above have different characteristics. The first method (FIG. 3) is simpler and stricter on what is an acceptable sequence of taps for a word in the lexicon. The second method (FIG. 4) is more complex but also more flexible. For example, the second method allows switching of letter pairs in a word. If the user mistapped “computation” as “computation”, the elastic matching methodology may flip the tapping points corresponding to letter “i” and “o” in order to reach a lower elastic distance. It may also be able to find the correct word even if a letter is missed all together or an additional key is tapped, due the elasticity in calculating shape distance. With regard to the second method, the concept of an elastic distance allows stretching and multiple points to be mapped onto one point. This is achieved with a dynamic programming routine, shown below (pseudo code) as applied to FIG. 5, which illustrates the alternative method of performing elastic matching through a graphical illustration.

Dynamic Programming Routine

function MIN-DISTANCE(unknown, prototype)

returns min-distance
n [symbol] LENGTH(unknown)
m [symbol] LENGTH(prototype)
Create a distance matrix d[n + 1, m + 1]
for each row i from 0 to n do

for each column j from 0 to m do

cost [symbol] COST[unknown, prototype]
if i = 0 and if j = 0 then

d[i,j] [symbol] cost

else if i = 0 then

d[i,j] [symbol] cost + d[i][j − 1]

else if j = 0 then

d[i,j] [symbol] cost + d[i − 1][j]

else

d[i,j] [symbol] cost + MIN(d[i−1,j], d[i−1,j−1], d[i,j−1])

return(d[n,m] / MAX(n,m))

According to FIG. 5 and the above programming routine, a matrix is created with the column size of the number of points in the user-tapped sequence (unknown) and the row size of the number of points in the currently selected word from the dictionary (prototype). Iterating through the matrix row-by-row the matrix position (i,j) is filled with the cost between point i and j and an additional cost that depends on where the point is located in the matrix. The cost function can be any similarity function between points. One intuitive and often used cost function is the spatial distance, e.g. the L2-norm, between the points.

At the first row and first column position ((i, j)=(0, 0)), the cell value is set to the cost between the first two points in the sequences. If they are in any other position in the matrix, then the cost between the points is computed and summed with the cumulative cost of the cells traversed previously. In another row and at the first column ((i, j)=(i≠0, 0)) it is the cumulative cost from the cell above. In the first row and in any column position except the first one it is the cumulative cost from the cell at the previous column position. Otherwise, it is the minimum cost from the previous cells and the diagonal cell. In the end the invention normalizes the total cost with the longest path traversed in the matrix. Normalizing the total cost is preferable because, otherwise, longer matches would have a disproportion cost compared to shorter matches.

However, the elastic matching technique described above is merely an example of a way to perform an elastic match, and the invention is not limited to this one particular elastic matching technique. Nonetheless, the elastic matching process provided by the invention yields the best fit between a prototype and the unknown sample, with some corresponding points stretched to their optimal corresponding points as illustrated in FIG. 5.

According to the invention, first a delimiter method is chosen. Among other possible solutions such as a special-purpose physical button on the user's non-dominant hand, the invention uses a set of delimiting characters. These characters are word delimiters in normal word processing, e.g. the tab-character, the space-character, semi-colon, etc. Suppose there are N number of taps, as two-dimensional point data {p₁, p₂, . . . , p_{N}} occurred from the previous to the current delimiter. For each word w in the lexicon, wε{w::w is a word with N letters}, the invention computes:

$${D}_{w} = \frac{1}{N} {\sum }_{i = 1}^{N} d ( {p}_{i} , {q}_{i} ) \qquad ( 3 )$$

where pᵢ is the two-dimensional point of the i th tap and qᵢ is the center of the key corresponding to the i th letter in w; d is, among other possible functions, the two-dimensional Euclidian distance. To avoid matching unlikely words the invention imposes a threshold Tₚ on each point-to-point distance. If d(p,q)>Tₚ, D_{W} is set to ∞. The cumulative distance between the points is then normalized with respect to the number of points in the pattern.

Among all candidate words the invention then obtains a subset comprising the words with a D_{w} value below some threshold T_{w}. These words are then returned to the system as a ranked list, wherein the system output is the word with the smallest D_{w} value. The threshold T_{w} can be a fixed threshold, for example the diameter of a key on the keyboard layout, or a more adaptive one, e.g. by looking at the distribution of the point-to-point distances. It is also possible to examine the actions of the user to determine the threshold dynamically. For instance, if many auto-corrections are followed by an immediate deletion by the user, the threshold can be increased by some calculated amount.

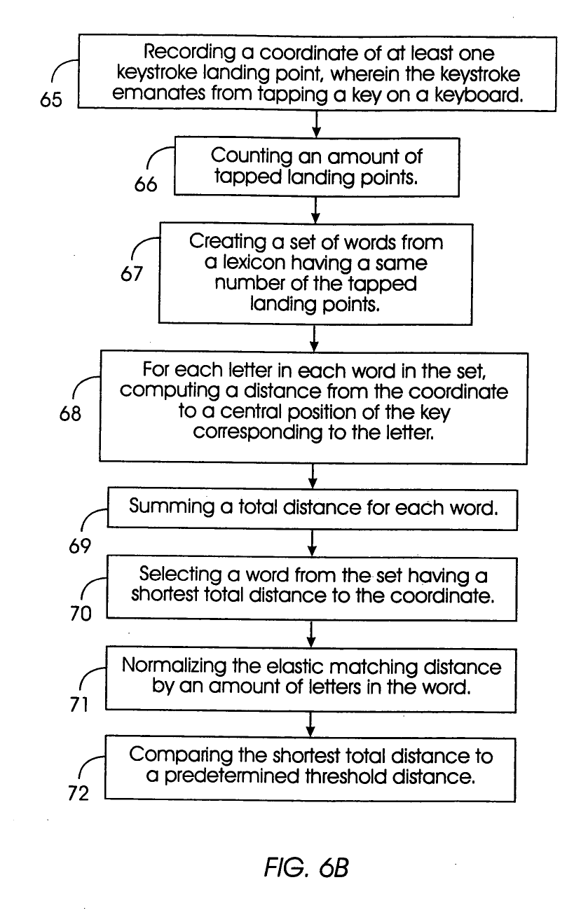

As shown in FIG. 6(A), the invention provides a method of relaxing typing accuracy comprising comparing 60 the geometric pattern formed by an inputted sequence of points to a pattern formed by lexical entry of sequences, calculating 61 a distance between the geometric pattern formed by the inputted sequence of points and the pattern formed by the letters corresponding to the lexical entry of sequences, and determining 62 a word by selecting a shortest distance between the inputted sequence of points and letters corresponding to the lexical entry of sequences, wherein the distance is a mean distance of all inputted sequence of points, or wherein the distance is an elastic matching distance between the inputted sequence of points and the lexical entry of sequences. The method further comprises normalizing 63 the elastic matching distance by an amount of letters in the word. Moreover, the method further comprises comparing 64 the shortest total distance to a predetermined threshold distance, wherein the invention outputs the word if the shortest total distance is smaller than the predetermined threshold distance, and wherein the invention outputs the letters tapped if the shortest total distance is greater than the predetermined threshold distance.

In an alternative embodiment, as illustrated in FIG. 6(B), the invention provides a method of relaxing typing accuracy comprising recording 65 a coordinate of at least one keystroke landing point, wherein the keystroke emanates from tapping a key on a keyboard, counting 66 an amount of tapped landing points, creating 67 a set of words from a lexicon having a same number of the tapped landing points, for each letter in each word in the set, computing 68 a distance from the coordinate to a central position of the key corresponding to the letter, summing 69 a total distance for each word, and selecting 70 a word from the set having a shortest total distance to the coordinate, wherein the distance is a mean distance of all the tapped landing points for each word, or wherein the distance is an elastic matching distance between the tapped landing points and the coordinate. The method further comprises normalizing 71 the elastic matching distance by an amount of letters in the word, and comparing 72 the shortest total distance to a predetermined threshold distance. Furthermore, the invention outputs the word if the shortest total distance is smaller than the predetermined threshold distance, and outputs the letters tapped if the shortest total distance is greater than the predetermined threshold distance.

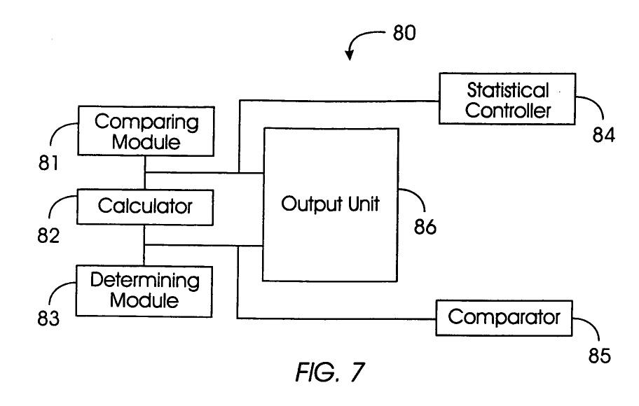

Also, as shown in FIG. 7, the invention provides a system 80 of relaxing typing accuracy comprising a comparing module 81 configured to compare an inputted sequence of points to a lexical entry of sequences, a calculator 82 configured to calculate a distance between the inputted sequence of points and letters corresponding to the lexical entry of sequences, and a determining module 83 configured to determine a word by selecting a shortest distance between the inputted sequence of points and letters corresponding to the lexical entry of sequences, wherein the distance is a mean distance of all inputted sequence of points, or wherein the distance is an elastic matching distance between the inputted sequence of points and the lexical entry of sequences. The system further comprises a statistical controller 84 configured to normalize the elastic matching distance by an amount of letters in the word, a comparator 85 configured to compare the shortest total distance to a predetermined threshold distance, and an output unit 86 configured to output the word if the shortest total distance is smaller than the predetermined threshold distance, or output the letters tapped if the shortest total distance is greater than the predetermined threshold distance.

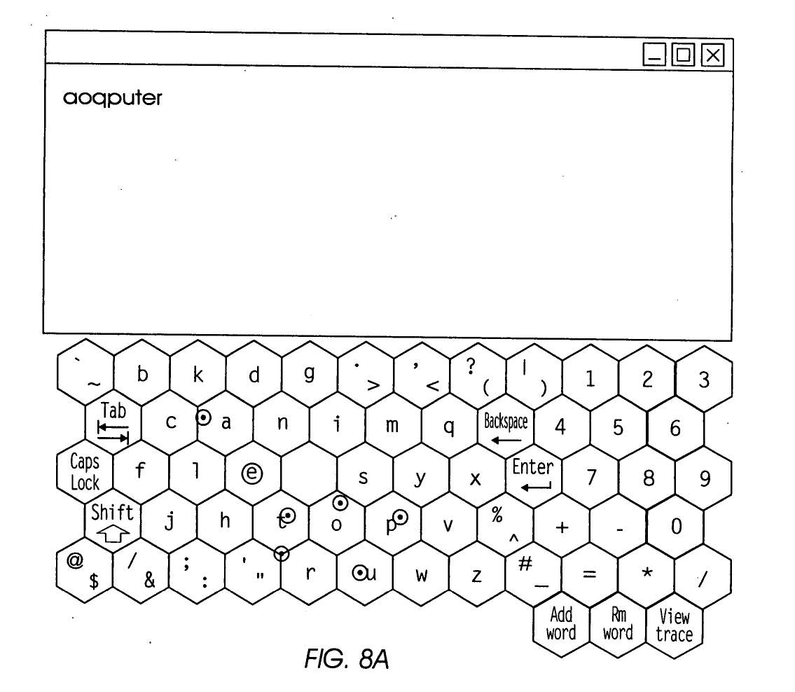

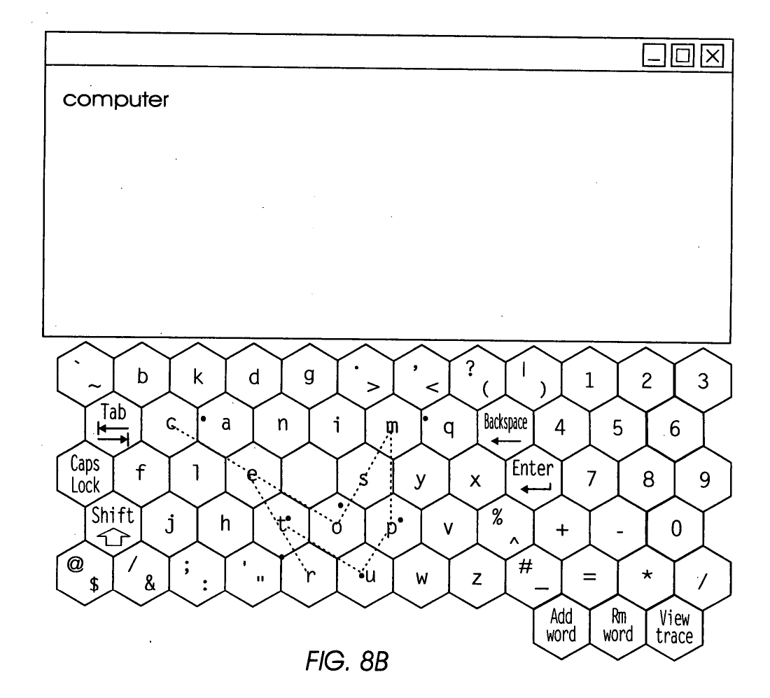

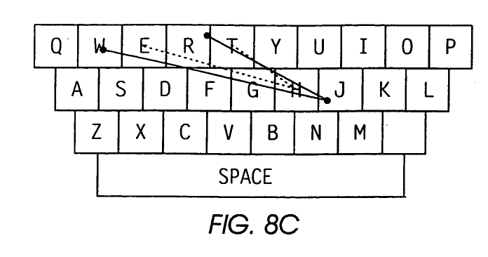

FIGS. 8(A) and 8(B) illustrate an example of the typing relaxation effect on an ATOMIK keyboard. FIG. 8(A) shows what the user actually typed. The user intended to type the word “computer”, but missed keys “c” and “m” resulting in the mistyped word “aoqture”. The keystrokes are denoted by the encircled dots. However, even though the user missed the letter “c” and “m” in “computer”, the system provided by the invention is able to give the user the intended word, “computer”, as shown in FIG. 8(B). The highlight superimposed on the word “computer” on the monitor shows the user that some correction has been applied to that word. Moreover, a user could click on the word and select a different candidate word, including the one that was typed if so desired. In FIG. 8(C) a user tapping trace is shown where the user clearly intended to write the word “the” (the pattern for the intended word “the” is shown in dotted lines). However, all letters returned verbatim from the keyboard are wrong (the pattern for the mistapped word “rjw” is shown in solid lines, with the position of the tapped position indicated by the solid dots connecting the solid lines), hence if a system did not look for the pattern of the tap sequence no feasible correction is possible. Using the relaxation technique of described above, the invention can find the correct word since the pattern of “the” is the only pattern that is sufficiently close to the user tap sequence.

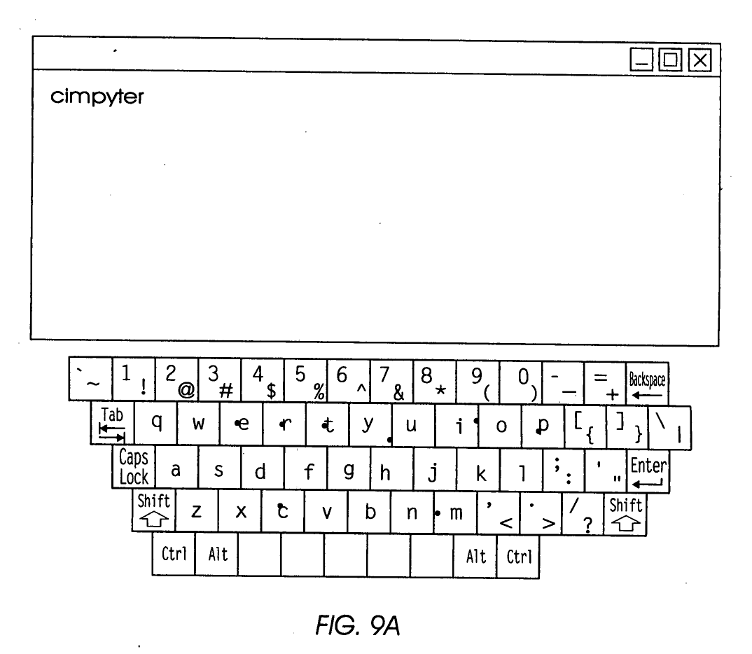

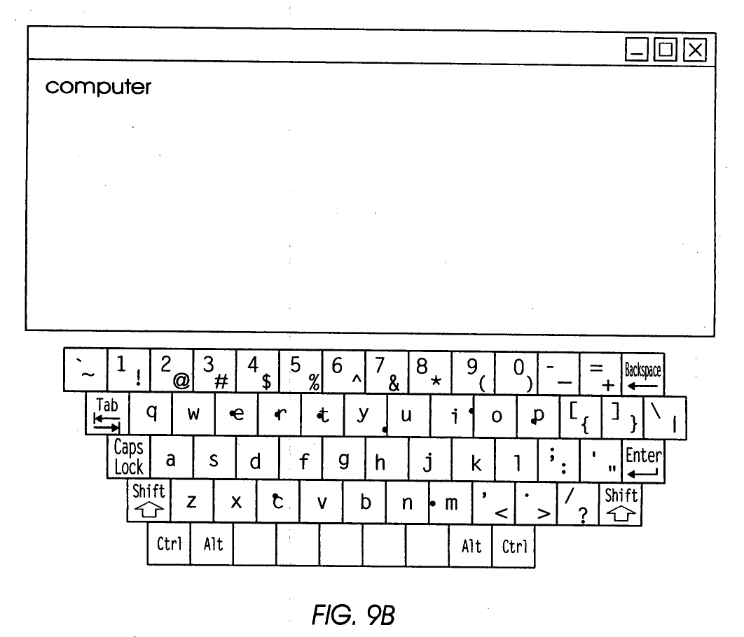

FIGS. 9(A) and 9(B) illustrate a similar example on the QWERTY layout, where the user mistypes “cimpyter”, and the system recognizes the correct word to be “computer”. Furthermore, the system can correct a word even though all keys of the desired word are missed, since the language redundancy and the pattern of the user's tapping leads to only a few feasible candidate words, of which the one most resembling to the user's tapped pattern is returned. The invention is particularly advantageous in that it can be used in all text entry environments interacting with a keyboard where a tap is a continuous variable and the process of tapping is serial. This includes virtual keyboards used with a single stylus, eye-typing and other methods where a single point is controlled by the user and the user selects item by item serially. The matching method provided by the invention is simple and conservative. Specifically if the user taps on all the correct keys of a word, no other word can be closer. Also, the invention is very easy to implement and because the invention compares very few points, exhaustive (linear) searching through the lexicon is very fast. Also, faster implementation is possible by indexing the patterns, for example by areas on the keyboard.

One difference between the invention and the conventional approaches, such as auto correction in today's popular work processors is the use of geometry based on the keyboard layout used. For example, for stylus tapping on a QWERTY layout, if the user tapped t-g-e, “the” will be given to the user given the proximity of the pattern t-h-e and t-g-e on a QWERTY layout. However, if a user tapped t-z-e, although it also has one letter of mismatch from “the”, “the” will not be given because the pattern shape t-z-e is very different from the pattern shape of the. From a user behavior perspective, a user is much likely to mistap t-h-e as t-g-e, but much less likely to mistap t-z-e as -t-h-e since t-z-e constitutes a very different path trajectory on the QWERTY layout. In fact, the geometric pattern technique provided by the invention is applicable to many other pattern recognition methods without departing from the spirit of the invention. For example, it is possible to match the line segments in a pattern to select the best word match rather than points.

Furthermore, according to the invention, the space key is used as a segmentation cue in matching tapping sequence with words in a lexicon. However, it is also possible to use other methods as a segmentation signal. For example, the user may press on a physical key or a physical button with his or her non-dominant hand at the end of each work input. Essentially, the invention provides a simple approach to pattern recognition and includes the following properties: First, the invention is scalable to a lexicon that practically includes all words needed by a user. Second, no user training is required for the recognition methodology.

While the invention has been described in terms of preferred embodiments, those skilled in the art will recognize that the invention can be practiced with modification within the spirit and scope of the appended claims.

### REFERENCES

[1] Getschow, C. O. et al., “A Systematic Approach to Design a Minimum Distance Alphabetical Keyboard” Paper presented at the RESNA (Rehabilitation Engineering Society of North America) 9th Annual Conference, Minneapolis, Minn., 1986.
[2] MacKenzie, I. S. et al., “The Design and Evaluation of a High-Performance Soft Keyboard,” Proceeding of CHI '99, 32-39, Pittsburgh, Pa., 1999.
[3] Zhai, S. et al., “Performance Optimization of Virtual Keyboards,” Human-Computer Interaction, 17(2, 3), 89-129, 2002.
[4] Shannon, C. E., “A Mathematical Theory of Communication,” The Bell System Technical Journal, 27, 379-423, 623-656, 1948.
[5] Ward, D. et al., “A Data Entry Interface Using Continuous Gesture and Language Models,” Proc. UIST 2000, ACM, 129-136.
[6] Darragh, J. J. et al., “Adaptive Predictive Text Generation and the Reactive Keyboard. Interacting with Computers,” 3 (1), 27-50, 1991; Kukich, K., “Techniques For Automatically Correcting Words in Text,” ACM Computing Surveys, 24 (4), 377-439, 1992.
[7] Goodman, J. et al., “Language Modeling for Soft Keyboards,” Proc. AAAI, 419-424, 2002.
[8] Tappert, C. C., “Cursive Script Recognition by Elastic Matching,” IBM Journal of Research & Development, 26 (6), 756-771, 1982.
[9] Dvorak, A. et al., W. L., & Ford, G. C., Typewriting Behavior, New York, American Book Company (1936).

1. A method of relaxing typing accuracy, said method comprising:
comparing a geometric pattern formed by an inputted sequence of points to a pattern formed by lexical entry of sequences;
calculating a distance between said geometric pattern and the pattern formed by letters corresponding to said lexical entry of sequences; and
determining a word by selecting a shortest distance between said inputted sequence of points and letters corresponding to said lexical entry of sequences.

2. The method of claim 1, wherein said distance is a mean distance of all inputted sequence of points.

3. The method of claim 1, wherein said distance is an elastic matching distance between said inputted sequence of points and said lexical entry of sequences.

4. The method of claim 3, further comprising normalizing said elastic matching distance by an amount of letters in said word.

5. The method of claim 1, further comprising comparing said shortest total distance to a predetermined threshold distance.

6. The method of claim 5, further comprising outputting said word if said shortest total distance is smaller than said predetermined threshold distance.

7. The method of claim 5, further comprising outputting letters tapped if said shortest total distance is greater than said predetermined threshold distance.

8. A method of relaxing typing accuracy, said method comprising:
recording a coordinate of at least one keystroke landing point, wherein said keystroke emanates from tapping a key on a keyboard;
counting an amount of tapped landing points;
creating a set of words from a lexicon having a same number of said tapped landing points;
for each letter in each word in said set, computing a distance from said coordinate to a central position of said key corresponding to said letter;
summing a total distance for each word; and
selecting a word from said set having a shortest total distance to said coordinate.

9. The method of claim 8, wherein said distance is a mean distance of all said tapped landing points for each word.

10. The method of claim 8, wherein said distance is an elastic matching distance between said tapped landing points and said coordinate.

11. The method of claim 10, further comprising normalizing said elastic matching distance by an amount of letters in said word.

12. The method of claim 8, further comprising comparing said shortest total distance to a predetermined threshold distance.

13. The method of claim 12, further comprising outputting said word if said shortest total distance is smaller than said predetermined threshold distance.

14. The method of claim 12, further comprising outputting letters tapped if said shortest total distance is greater than said predetermined threshold distance.

15. A system of relaxing typing accuracy comprising:
a comparing module configured to compare an inputted sequence of points to a lexical entry of sequences;
a calculator configured to calculate a distance between said inputted sequence of points and letters corresponding to said lexical entry of sequences; and
a determining module configured to determine a word by selecting a shortest distance between said inputted sequence of points and letters corresponding to said lexical entry of sequences.

16. The system of claim 15, wherein said distance is a mean distance of all inputted sequence of points.

17. The system of claim 15, wherein said distance is an elastic matching distance between said inputted sequence of points and said lexical entry of sequences.

18. The system of claim 17, further comprising a statistical controller configured to normalize said elastic matching distance by an amount of letters in said word.

19. The system of claim 15, further comprising a comparator configured to compare said shortest total distance to a predetermined threshold distance.

20. The system of claim 19, further comprising an output unit configured to output said word if said shortest total distance is smaller than said predetermined threshold distance.

21. The system of 19, further comprising an output unit configured to output letters tapped if said shortest total distance is greater than said predetermined threshold distance.

22. A system of relaxing typing accuracy comprising:
means for comparing a geometric pattern formed by an inputted sequence of points to a pattern formed by lexical entry of sequences;
means for calculating a distance between said geometric pattern and the pattern formed by letters corresponding to said lexical entry of sequences; and
means for determining a word by selecting a shortest distance between said inputted sequence of points and letters corresponding to said lexical entry of sequences.
